(19) United States
(12) Patent Application Publication
(10) Pub. No.: US 2010/0167715 A1
(43) Pub. Date: Jul. 1, 2010

(54) Method and Apparatus for Social Networking in a Communication Network

(75) Inventors: Marcio Bertoni Domene, Valinhos (BR); Flavio Mazziero, Campinas (BR)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/347,203

(22) Filed: Dec. 31, 2008

(51) Int. Cl. H04M 3/00; H04W 4/00

(52) U.S. Cl. 455/418; 455/466

(57) ABSTRACT

In a communication network, a method and apparatus for social networking in a communication network includes detecting a characteristic motion of a communication device and identifying at least one contact information from a contact list of the communication device in response to detecting the characteristic motion of the communication device. The method further includes initiating a communication session with the identified contact information.

### FIELD OF THE DISCLOSURE

The present disclosure relates generally to communication devices and more specifically to a method for social networking.

### BACKGROUND

Communication among individuals in a wireless network is typically selective and purposeful. Although telecommunications generally enhance socialization, in another realm it can also potentially diminish social interaction with people within the individual's contact list. People in general have become busy with their job and family responsibilities and therefore are not able to keep in touch with friends. Carriers or service providers also wish to increase network traffic as well as mobile phone sales. Although phone users can create call lists and phone books to known parties, existing phones currently do not have a means of encouraging further socialization.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a front view diagram illustrating a communication device held in a human hand in accordance with some embodiments.

FIG. 2 is a side view diagram illustrating a communication device held in a human hand in accordance with some embodiments.

FIG. 3 is a block diagram illustrating a communication device in accordance with some embodiments.

FIG. 4 is a flowchart of a method for social networking in a communication network in accordance with some embodiments.

FIG. 5 is a flowchart of a method for social networking in a communication network in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Pursuant to various embodiments, a method for social networking in a communication network includes detecting a characteristic motion of a communication device and identifying at least one contact information from a contact list of the communication device in response to detecting the characteristic motion of the communication device. The method further includes initiating a communication session with the identified contact information.

In another embodiment, the method includes initiating a communication session on a communication device and providing an option to a user of the communication device for identifying contact information from a contact list for the communication session. The method further includes detecting a characteristic motion of the communication device after providing the option to the user and identifying at least one contact information from a contact list for the communication session, wherein identification of the at least one contact information is based on the detection of the characteristic motion.

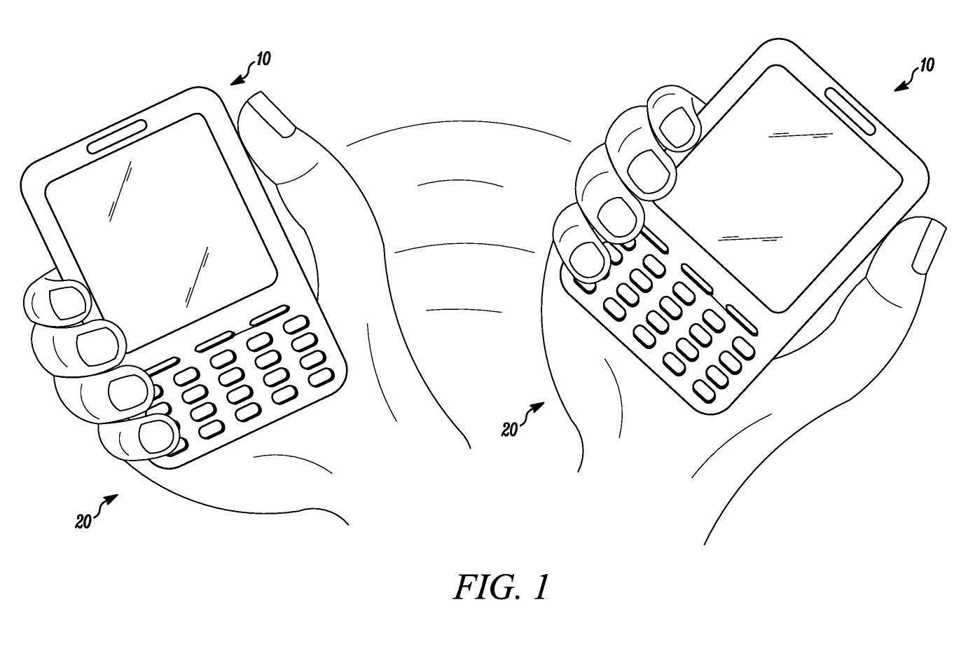

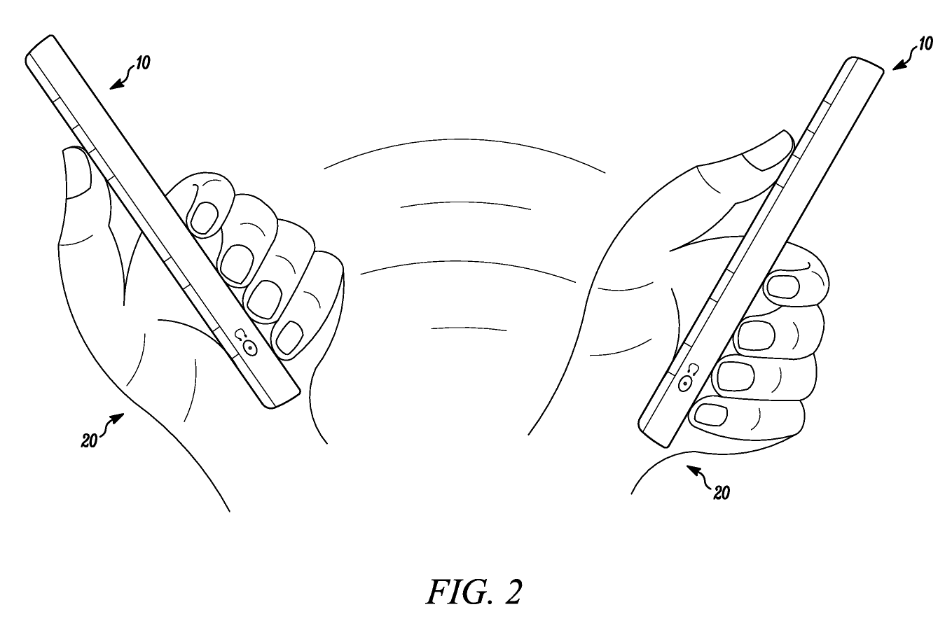

Referring now to the figures, FIG. 1 is front view diagram illustrating a communication device 10 held in a human hand 20 in accordance with some embodiments of the present invention. As shown in FIG. 1, the communication device 10 is shaken using the human hand 20. In this case, a shaking motion of the human hand 20 results in shuffling of the communication device's 20 contact list. Similarly, FIG. 2 is a side view diagram illustrating the communication device 10 held in the human hand 20 in accordance with some embodiments of the present invention. In this case, the communication device 10 is shaken in a different direction as an alternate to the shaking motion of the communication device 10 shown in FIG. 1. It should be understood that the communication device 10 is shown being held using the human hand 20 only for illustration purpose; however the communication device 10 may be held using other known means also.

The mobile communication device 10 may be implemented as a cellular telephone (also called a mobile phone). The mobile communication device 10 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (UO1P). The communication device 10 in FIG. 1 and FIG. 2 is shown as a wireless communication device, e.g. a mobile phone; however it should be understood that the communication device 10 may also be a wired communication device. In another example, the communication device 10 may also be an accessory, such as a computer mouse, attached to another communication device, such as a personal computer or laptop.

In operation, the communication device 10 may detect a characteristic motion. In one embodiment, this characteristic motion of the communication device 10 may be a shaking motion of the communication device 10. In this case, the communication device 10 includes an accelerometer that will detect the shaking motion and initiate an application corresponding to the characteristic motion of the communication device 10.

In another embodiment, the characteristic motion is an input using a soft key attached to the communication device 10. In this case, the communication device 10 may include the soft key as a key on a keyboard attached to the communication device 10. The soft key may also be an application key that is a part of the application corresponding to the characteristic motion of the communication device 10. For example, the application key is pressed using a touch screen of the communication device 10 or is selected using a scroll key of the communication device 10.

In another embodiment, the characteristic motion may be a shaking of an accessory attached to the communication device 10. For example, in case the communication device 10 may be a personal computer and the accessory may be a computer mouse attached to the personal computer. In this case, the personal computer will detect a shaking motion of the computer mouse and initiate an application corresponding to the shaking motion.

In yet another embodiment, the characteristic motion may be a forceful movement of images in front of the camera attached to the communication device 10. For example, after the camera and the associated application is turned on, the user of the communication device 10 may then shake the hand in front of the camera and the communication device 10 may detect that shaking and initiate an application corresponding to the shaking motion. The forceful movement of images may be detected by a processor attached to the camera which may then initiate the application corresponding to the movement of images. The camera may be an internal camera of the communication device 10 or may be a separate camera attached to the communication device. For example, if the communication device 10 is a laptop or a personal computer, then the camera may either be an internal camera or a separate webcam attached to the communication device 10.

In another embodiment, touch sensitive sensors may be present within the communication device 10. These touch sensitive sensors are capable to distinguishing between shaking due to the normal usage of the communication device 10 and intentional shaking by the user of the communication device 10. The touch sensitive sensor may be a capacitative or resistive sensor used to detect whether the communication device 10 is present in the hand of the user or not. The touch sensitive sensors are used to distinguish the characteristic motion of the communication device 10 from other random motions such as an earthquake or vibratory motions of a vehicle. In case the communication device 10 is found to be present in the hand of the user then the application corresponding to the shaking motion of the communication device 10 is activated.

The application corresponding to the shaking motion and/or the characteristic motion of the communication device 10 is described herein. The communication device 10 after detecting the characteristic motion of the communication device 10 shuffles a contact list of the communication device 10. The communication device 10 then identifies at least one contact information from the contact list of the communication device 10. This contact list may be locally stored in the communication device 10 or may be remotely located on a storage device. The communication device 10 then initiates a communication session with the identified contact information. The communication session may be sending of a text message, a sending voice message, establishing a voice call, establishing a push-to-talk session, or sending a multimedia based message.

In one embodiment, an option to initiate the communication session may be provided to a user of the communication device 10 before actually initiating the session. This option may be displayed on a screen or a separate display attached to the communication device 10. The user then makes a choice of initiating the communication session with the identified contact information (also called as a recipient for the communication session) or shaking the communication device again to shuffle contact list and identify a different recipient for initiating the communication session. In another embodiment, shuffling of a contact list, identification of a contact information, and initiation of a communication session are repeated based on the number of shakes imparted on the communication device 10, intensity of the shake of the communication device 10, or time duration associated with the shake.

In one example, the contact list is a predetermined list of contact numbers with respective contact names, a predefined list of electronic mail addresses with respective contact names, or a predefined list of images with respective contact names. In another example, the contact information is a contact number associated with a contact name, an electronic mail address associated with a contact name, or an image associated with a contact name. The contact information may include user identification information, contact addresses associated with the user, The contact addresses of the user may include user's phone number, either mobile or landline, user's email address.

In case of sending an email, the communication device may extract the email address and convert the extracted email address into the corresponding Uniform Resource Locator (URL) link. In case of sending a message using the Short Messaging Service (SMS), the communication device 10 may extract the phone number included in the contact information and also determine the associated service provider. The communication device 10 may then provide a text box for the user to type in a text message and send the typed text to the identified contact. The user may also insert text templates in the text box that are available in a memory of the communication device 10. In case of making a phone call, the communication device 10 may extract the contact number or the phone number of the user.

The shuffling of the contact list is based on a number of shakes of the communication device 10, intensity of a shake of the communication device 10, and time duration of the shake. The continuity of the shuffling of the contact list is based on duration of the shake of the communication device 10 or an intensity of the shake of the communication device 10. For example, the shuffling of the contact list may continue until the communication device 10 is continuously shaken. The shaking motion of the communication device 10 is imparted by tilting of the communication device 10 or rotating the communication device 10. For example, the shaking motion may be imparted by titling the communication device 10 left and right continuously (as shown in FIG. 1 and FIG. 2) for a preset number of times causing the communication device 10 to shuffle the contact list. In another example, the communication device 10 may be rotated to 180 degrees to cause the shaking motion of the communication device 10.

In one embodiment, the communication device 10 initiates a communication session. For example, the user of the communication device 10 initiates the communication session by typing a text message. The communication device 10 then provides an option to the user for identifying the contact information from the contact list for the communication session. The communication device 10 detects the characteristic motion of the communication device 10 that may be a shaking motion of the communication device 10, an input using a soft key attached to the communication device 10, a shaking of an accessory attached to the communication device 10, or by forceful movement of images in front of the camera attached to the communication device 10. The communication device 10 shuffles the contact and identifies a contact information from the contact list for the communication session. The identification of the contact information is based on the detection of the characteristic motion of the communication device 10.

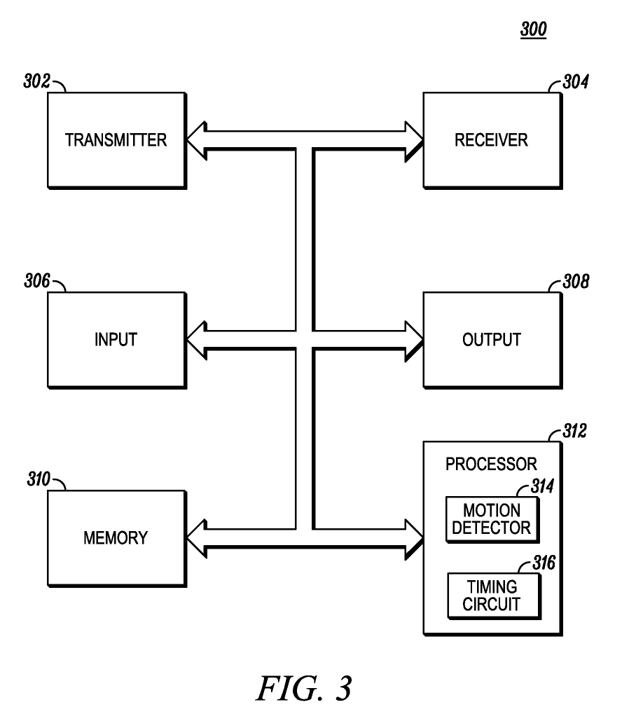

Referring to FIG. 3, a communication device 300, such as a mobile phone, includes a transmitter 302, a receiver 304, an input (I/P) 306, an output (O/P) 308, a memory 310, and a processor 312. The processor 312 further includes a motion detector 314 and a timing circuit 316. The user of the communication device 300 initiates a communication session using the input 306. The processor 312 provides an option to the user for identifying a recipient for the communication session. The motion detector 314 then detects a characteristic motion of the communication device 300. In this case, the time circuit 316 may also record the duration of the characteristic motion and accordingly the processor 312 shuffles the contact list to identify a contact information for the communication session. The motion detector 314 detects the intensity of the shake and accordingly the processor 312 shuffles the contact list to identify a contact information for the communication session.

In one operation, the motion detector 314 detects the characteristic motion of the communication device 300 and passes on an instruction to the processor 312 to shuffle the contact list of the communication device 300. The processor 312 then identifies a contact information from the contact list and provides the user of the communication device 300 with an option to initiate the communication with the identified contact. The user in this case may then either choose to initiate the communication session with the identified contact or may choose to shuffle the contact list further to identify another contact and initiate a communication session with that identified contact. This process may be repeated based on the user of the communication device 300. The characteristic motion includes a shaking of the communication device 300, an input received using a soft key attached to the communication device 300, or a shaking of an accessory attached to the communication device, or by forceful movement of images in front of the camera attached to the communication device 10.

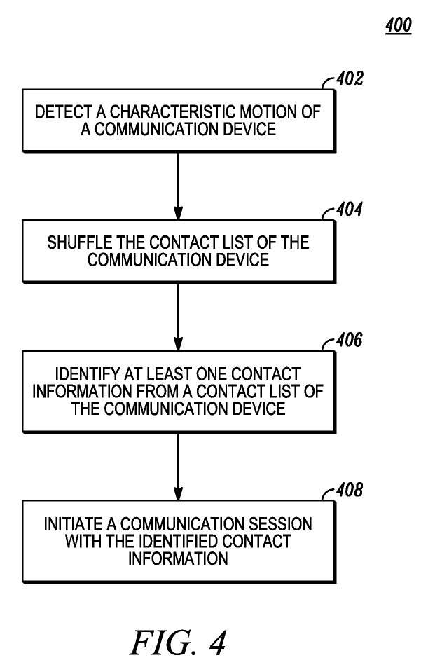

Referring to FIG. 4, a flowchart of a method for social networking in a communication network in accordance with some embodiments begins with the detection (402) of a characteristic motion of a communication device. The contact list of the communication device is then shuffled (404) in response to the detection of the characteristic motion of the communication device. At least one contact and/or contact information is identified (406) from the contact list of the communication device. A communication session is then initiated (408) with the identified contact.

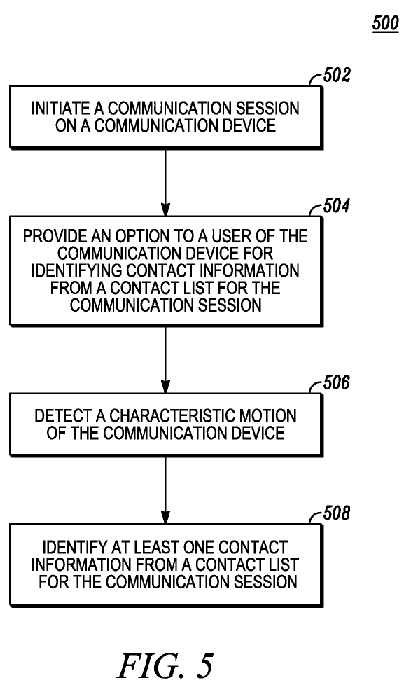

Referring to FIG. 5, a flowchart of a method for social networking in a communication network in accordance with some embodiments begins with the initiation (502) of a communication session on a communication device. The user of the communication device is then provided (504) with an option for identifying contact information from a contact list for the communication session. A characteristic motion of the communication device is detected (506) and at least one contact information is identified (508) from a contact list of the communication device.

Advantages of the various embodiments may include an interactive way of choosing contacts from the contact lists, generate more revenue for the service providers, and improve social networking with friends. Those skilled in the art will realize that the above advantages and other advantages described above are merely illustrative and are not meant to be a complete rendering of all of the advantages of the various embodiments.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for social networking in a communication network, the method comprising:
detecting a characteristic motion of a communication device;
identifying at least one contact information from a contact list of the communication device in response to detecting the characteristic motion of the communication device; and
initiating a communication session with the identified contact information.

2. The method of claim 1 further comprising:
shuffling the contact list of the communication device before identifying the at least one contact information.

3. The method of claim 2, wherein the characteristic motion of the communication device comprises at least one of a shaking motion of the communication device, an input using a soft key attached to the communication device, and a shaking of an accessory attached to the communication device.

4. The method of claim 3, wherein shuffling of the contact list is based on at least one of number of shakes of the communication device, intensity of a shake of the communication device, and time duration of the shake.

5. The method of claim 3, wherein a continuity of shuffling the contact list is based at least on one of a duration of a shake of the communication device and an intensity of the shake of the communication device.

6. The method of claim 3, wherein the shaking motion of the communication device is imparted by at least one of tilting the communication device and rotating the communication device.

7. The method of claim 1, wherein initiating the communication session comprises at least one of sending a text message, sending a voice message, establishing a voice call, establishing a push-to-talk session, and sending a multimedia based message.

8. The method of claim 3, further comprising:
repeating the shuffling, the identifying, and the initiating based on at least one of number of shakes of the communication device, intensity of a shake of the communication device, and time duration of the shake.

9. The method of claim 1, wherein the contact list is at least one of a predefined list of contact numbers with respective contact names, a predefined list of electronic mail addresses with respective contact names, and a predefined list of images with respective contact names.

10. The method of claim 1, wherein the contact information is at least one of a contact number associated with a contact name, an electronic mail address associated with a contact name, and an image associated with a contact name.

11. The method of claim 1, further comprising:
providing an option to a user for initiating the communication session.

12. A method for social networking in a communication network, the method comprising:
initiating a communication session on a communication device;
providing an option to a user of the communication device for identifying contact information from a contact list for the communication session;
detecting a characteristic motion of the communication device after providing the option to the user; and
identifying at least one contact information from a contact list for the communication session, wherein identification of the at least one contact information is based on the detection of the characteristic motion.

13. The method of claim 12 further comprising:
shuffling the contact list of the communication device before identifying the at least one contact information.

14. The method of claim 13, wherein the characteristic motion of the communication device comprises at least one of a shaking motion of the communication device, an input using a soft key attached to the communication device, and a shaking of an accessory attached to the communication device.

15. The method of claim 14, wherein shuffling the contact list is based on at least one of number of shakes of the communication device, intensity of a shake of the communication device, and time duration of the shake.

16. The method of claim 14, wherein a continuity of shuffling the contact list is based on at least one of an intensity of a shake and a duration of a shake.

17. The method of claim 14, wherein the shaking motion of the communication device is imparted by at least one of tilting the communication device and rotating the communication device.

18. The method of claim 14, further comprising:
repeating the detecting, the shuffling, and the identifying based on at least one of number of shakes of the communication device, intensity of a shake of the communication device, and time duration of the shake.

19. The method of claim 12, wherein the contact list is at least one of a predefined list of contact numbers with respective contact names, a predefined list of electronic mail addresses with respective contact names, and a predefined list of images with respective contact names.

20. The method of claim 12, wherein the contact information is at least one of a contact number associated with a contact name, an electronic mail address associated with a contact name, and an image associated with a contact name.

21. The method of claim 12, wherein initiating the communication session comprises at least one of sending a text message, sending a voice message, establishing a voice call, establishing a push-to-call session, and sending a multimedia based message.
